(19) United States
(12) Patent Application Publication
(10) Pub. No.: US 2013/0283868 A1
(43) Pub. Date: Oct. 31, 2013

(54) Chipless Key Head And Adapter For An Electronic Key

(71) Applicant: KABA ILCO CORP., Rocky Mount, NC (US)

(72) Inventors: Gary E. Morehart, Rocky Mount, NC (US); Samuel T. Adams, Winterville, NC (US); Ernest R. Allsbrook, JR., Smithfield, NC (US)

(73) Assignee: KABA ILCO CORP., Rocky Mount, NC (US)

(21) Appl. No.: 13/873,469

(22) Filed: Apr. 30, 2013

Related U.S. Application Data
(60) Provisional application No. 61/640,710, filed on Apr. 30, 2012.

(51) Int. Cl. E05B 19/00

(52) U.S. Cl. CPC E05B 19/00
USPC 70/447

(57) ABSTRACT

A key assembly for housing a transponder within a transponder holder wherein the key assembly has a key blade with connecting shoulders attached to the key blade, a key head having lock tabs that removably attach the connecting shoulders to the key head, and a transponder adapter for retaining at least one transponder. The transponder adapter is removably fitted within the key head and the transponder adapter facilitates the insertion and removal of at least one transponder within the key assembly.

### CROSS-REFERENCE TO PRIORITY APPLICATIONS

This application claims the benefit of and priority to U.S. Provisional Patent Application Ser. No. 61/640,710, filed Apr. 30, 2012, in the U.S. Patent and Trademark Office. This application incorporates the earlier provisional application by reference in its entirety.

### BACKGROUND OF THE INVENTION

The invention relates to keys and particularly to modular keys and key assemblies that incorporate electronic components such as transponders for remote signaling to a lock.

Key and lock systems have progressed over the years such that traditional keys with blades that fit into a cylinder or other lock mechanism are being improved with electronic systems. Many keys, particularly in the automobile industry, have the standard key blade with milling and biting cuts required to allow the key to engage a standard lock. In addition, modern keys, or “smart keys,” also include electronics such as a transponder that must be present and transmit an appropriate code for a driver to start the ignition on a vehicle.

U.S. Pat. No. 7,380,428 (Morehart et al. 2008) illustrates one kind of transponder key assembly with a key blade and head assembly. The key blade has appropriate milling and biting cuts to engage the ignition lock. As noted in the Morehart '428 patent, most transponders utilize the RFID technology in which an electromagnetic pulse from lock circuitry energizes the transponder in the key head. The transponder sends an electronic code to circuitry in the automobile allowing the ignition to start the car. The '428 patent is characterized in its disclosure of a key blank with a distinctive opening in the key head that receives a transponder holder shaped to fit within the distinctive opening. A removable transponder fits within the holder. Numerous kinds of keys are disclosed, each with a different shape for the opening in the key head and a corresponding transponder holder. In other words, each kind of key that is used for a special purpose (i.e., a particular vehicle), has a distinctively shaped opening that matches a respective transponder holder. The key head maintains the transponder holder in a secure position, but the transponder holder is removable from the key head by a specialized tool. This way, the transponder can be removed if necessary to fit into a replacement key with a matching key blade. This technique saves money if the key blade needs to be replaced by not requiring complete replacement of the key transponder and the transponder holder.

European Patent Application Publication No. EP0955430 (Davis et al. 1999) discloses another combination of a key and transponder in which the key head defines a slot into which a transponder holder fits snugly. A molded sheath fits around the key head, so the transponder of this early device was not removable.

Even with keys that have fittings suitable for holding a transponder, there exists a need in the art of smart keys for a key and transponder assembly that promotes efficient use of materials and allows for suitable transponder replacement without reproducing the entire key structure.

### SUMMARY OF THE INVENTION

The invention is directed to an adapter (or transponder adapter) that fits within a key assembly and is capable of holding more than one kind of transponder within the adapter (i.e., the adapter accommodates transponders that have respectively unique shapes, sizes, and dimensions). In this way, the adapter allows for a single piece, the adapter, to hold transponders that are designed for a respective purpose and therefore have a particular profile. For purposes of this invention, the term “transponder” includes any assembly (30, 32, 34, 36) that incorporates a transponder therein. As such, the term “transponder” includes the electronic device known as a transponder along with any housing or holder encapsulating the transponder.

The transponder adapter shown herein allows for multiple kinds of transponders to be placed in a single kind of key. Similarly, the transponder can be removed from that key and recycled for use in a different key.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is an exploded perspective view of an exemplary embodiment of the key assembly according to the present invention;

FIG. 2 is another exploded perspective view of an exemplary embodiment of the key assembly according to the present invention;

FIG. 3A is a perspective view of an exemplary embodiment of the transponder adapter of the key assembly according to the present invention; and

FIG. 3B is another perspective view of an exemplary embodiment of the transponder adapter of the key assembly according to the present invention;

FIG. 3C yet another perspective view of an exemplary embodiment of the transponder adapter of the key assembly according to the present invention;

FIG. 4 is another perspective view of an exemplary embodiment of the key assembly according to the present invention;

FIG. 5A is a top plan view of an exemplary embodiment of the key assembly according to the present invention; and

FIG. 5B is another top plan view of an exemplary embodiment of the key assembly according to the present invention.

### DETAILED DESCRIPTION OF THE INVENTION

The invention will now be described more fully hereinafter with reference to the accompanying drawings, in which multiple embodiments of the invention are shown. This invention may, however, be embodied in different forms and should not be construed as limited to the embodiments set forth herein. Rather, these embodiments are provided so that this disclosure will be thorough and complete and will fully convey the scope of the invention to those skilled in the art. Like numbers refer to like elements throughout. Further, like numbers with the prime notation refer to like or similar elements of the structure.

The invention is directed to a key assembly 10 for housing at least one transponder within a transponder adapter or holder. The key assembly 10 includes a key blade 75 having connecting shoulders 65 attached to the key blade, a key head 50 having lock tabs 60 that removably attach the connecting shoulders to the key head. Side portions 55 of the key head 50 correspondingly engage the connecting shoulders upon assembly. As configured, the key head is removably attachable to the key blade.

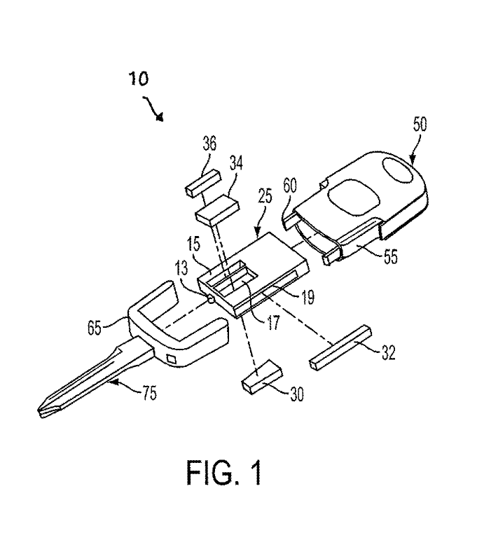

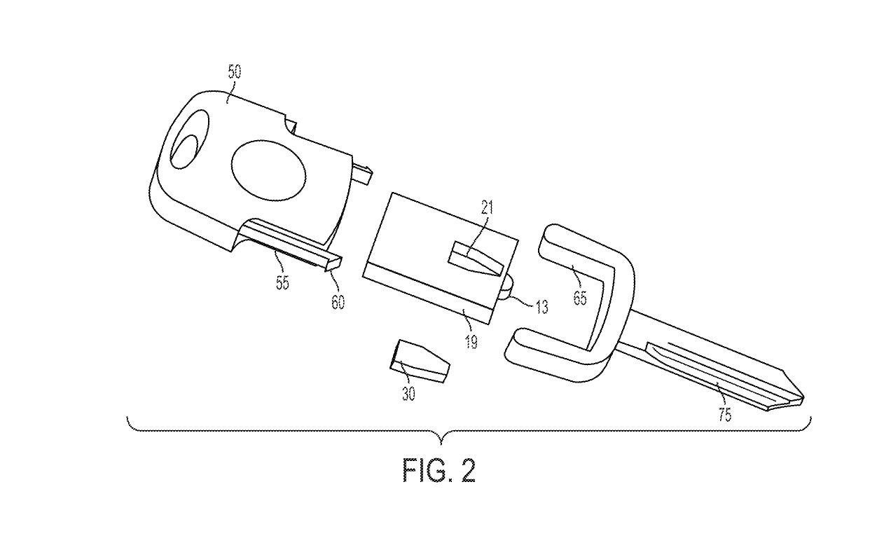

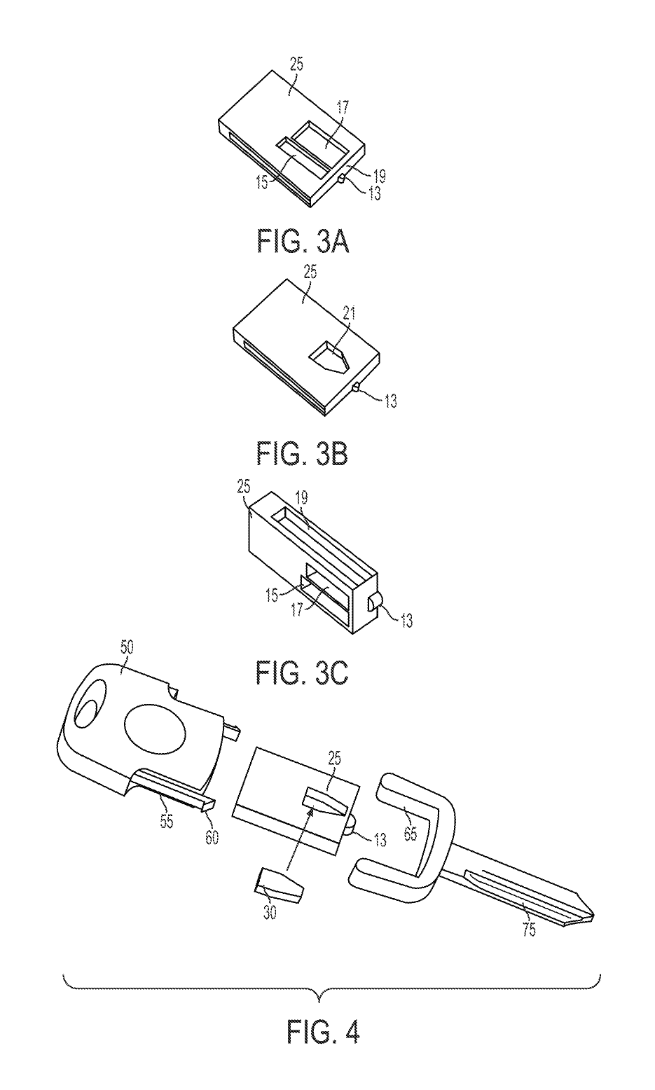

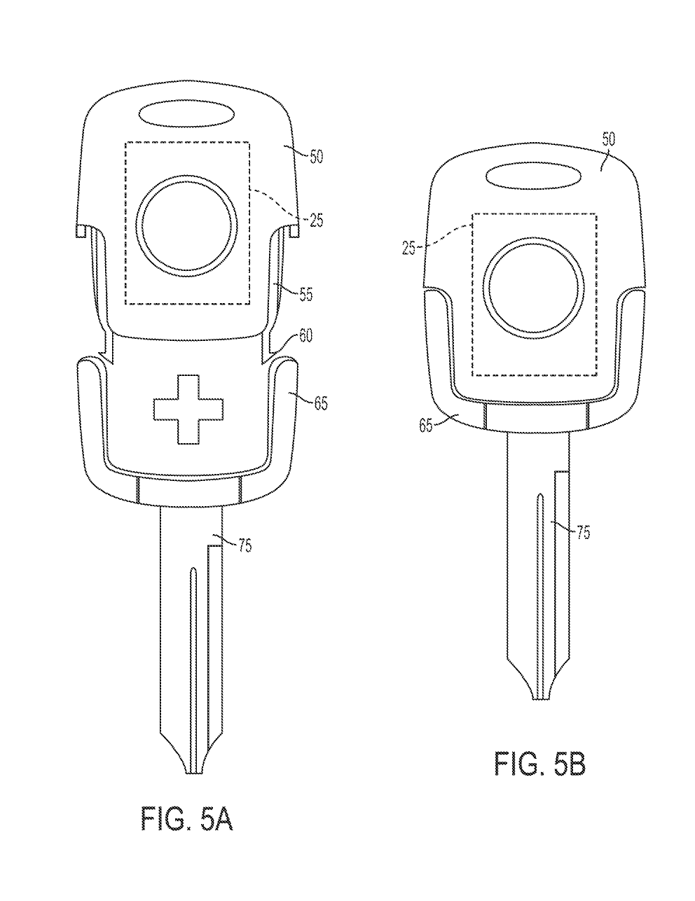

Advantageously, the key assembly 10 includes a transponder adapter 25 for retaining at least one transponder 30, 32, 34, 36. The key head 50 defines an open space within the key head for receiving the transponder adapter. It will be understood that the transponder adapter 25 may hold one, two, three, four or any number of transponders. The transponder adapter 25 is removably fitted within the key head 50. Advantageously, the transponder adapter facilitates the insertion and removal of at least one transponder within the key assembly. The transponder adapter 25 includes an anchor or tang 13 that removably attaches the adapter 25 to the key blade 75. As shown in FIG. 1, the anchor or tang 13 is a protrusion extending from the adaptor that engages the connecting shoulders 65 of the key blade.

The adapter 25 may secure one transponder within a key at one time, but the inventive adapter can accommodate more than one kind of transponder, making the adapter increasingly versatile over prior designs.

The transponder adapter 25 defines at least one cavity 15, 17, 19, 21 for retaining one or more of the transponders 30, 32, 34, 36. Accordingly, it will be understood that the transponder adapter may define one, two, three, four or any number of cavities for retaining the transponder(s). The cavity 15, 17, 19, 21 may be shaped in any number of shapes to include substantially rectangular, substantially polygonal, and substantially cylindrical or any number of shapes.

The transponder adapter 25 defines a top side, a bottom side, a front side, a back side, a first side and a second side. As shown in the figures, the adapter may include cavities 15, 17 in the top side of the adapter, a separate cavity 19 along a first or one side, and a final cavity 21 on the bottom side of the adapter.

In one embodiment, the top side defines at least one cavity. In another embodiment, the bottom side defines at least one cavity. In yet another embodiment, the first side defines at least one cavity. In still another embodiment, the second side defines at least one cavity. It will be understood that one or more sides of the transponder adapter 25 may define one or more cavities for removably retaining one or more of the transponders 30, 32, 34, 36. In an adaptive and efficient manner, the cavity or cavities 15, 17, 19, 21 define a shape and size corresponding to a shape and size of the transponder(s) 30, 32, 34, 36. Uniquely, the key blade 75, key head 50, and transponder adapter 25 are modular thus facilitating any number of combinations of transponders.

In one embodiment, and noted above, the transponder adapter 25 includes a plurality of cavities for removably retaining at least one transponder. The transponder adapter defines the cavity or cavities 15, 17, 19, 21. As configured, the transponder adapter 25, the transponder(s) 30, 32, 34, 36, and blade 75 of the combined key assembly 10 are all removably attachable from one another.

An advantageous feature includes the cavity or cavities 15, 17, 19, 21 having a shape that correspondingly engages the shape of the transponder or transponders 30, 32, 34, 36. As depicted in the figures, the transponder adapter 25 is removably positioned within the key head 50 of the key assembly 10 such that the transponder adapter is secured by the key blade of the key assembly.

In another embodiment, the invention includes a transponder adapter 25 releasably secured within a portion of a key assembly 10. The transponder adapter 25 defines a plurality of cavities 15, 17, 19, 21 for releasably containing a plurality of transponders 30, 32, 34, 36. In one embodiment, the plurality of cavities has open faces for readily accepting the transponder. These cavities may be defined by sides of the transponder adapter 25. As configured, the transponder adapter 25 is releasably secured within a key head 50 by a key blade 75 having connecting shoulders 65 that releasably secure to the key head.

In a particular embodiment, the transponder adapter includes four transponders positioned within cavities defined by the top side, the bottom side, and one side (e.g., a first side) of the transponder adapter. Further, the transponder adapter may be manufactured of recyclable materials such that the adapter is recyclable, thus reducing manufacturing costs. In yet another advantage, the transponder adapter is modular for use in combination with a selected key assembly. Moreover, the elements of the key assembly may be recyclable thereby further enhancing the economic efficiency of the key assembly and transponder adapter.

That which is claimed is:

1. A key assembly for housing at least one transponder within a transponder adapter, the key assembly comprising:
a key blade having connecting shoulders attached to said key blade;
a key head having lock tabs that removably attach said connecting shoulders to said key head such that said key head is removably attachable to said key blade;
a transponder adapter for retaining at least one transponder, said transponder adapter removably fitted within said key head;
wherein said transponder adapter facilitates the insertion and removal of said at least one transponder within said key assembly.

2. The key assembly according to claim 1, wherein said transponder adapter defines at least one cavity for retaining said at least one transponder.

3. The key assembly according to claim 2, wherein said at least one cavity is shaped.

4. The key assembly according to claim 2, wherein said transponder adapter defines a top side, a bottom side, a front side, a back side, a first side and a second side.

5. The key assembly according to claim 4, wherein said top side defines said at least one cavity.

6. The key assembly according to claim 4, wherein said bottom side defines said at least one cavity.

7. The key assembly according to claim 4, wherein said first side defines said at least one cavity.

8. The key assembly according to claim 4, wherein said second side defines said at least one cavity.

9. The key assembly according to claim 2, wherein said at least one cavity defines a shape and size corresponding to a shape and size of said at least one transponder.

10. The key assembly according to claim 1 wherein said key blade, said key head, and said transponder adapter are modular thus facilitating any number of combinations of transponders.

11. A transponder adapter for securing at least one transponder within a key assembly, the transponder adapter comprising:
a top side, a bottom side, front side, a back side, a first side, and a second side; and
a plurality of cavities defined by said transponder adapter for removably retaining at least one transponder;
wherein the transponder adapter, at least one transponder, and key assembly are all removably attachable to one another.

12. The transponder adapter according to claim 11 said transponder adapter defines a top side, a bottom side, front side, a back side, a first side and a second side.

13. The transponder adapter according to claim 11 defining at least one cavity for removably retaining said at least one transponder.

14. The transponder adapter according to claim 13, wherein said at least one cavity defines at least one shape that correspondingly engages the shape of said at least one transponder.

15. The transponder adapter according to claim 13, wherein said at least one cavity is defined by at least one of said top side, said bottom side, said front side, said back side, said first side, and said second side.

16. The transponder adapter according to claim 11:
wherein said transponder adapter is removably positioned within a key head of a key assembly; and
wherein said transponder adapter is secured within said key head by a key blade of a key assembly.

17. A transponder adapter releasably secured within a portion of a key assembly, said transponder adapter comprising:
a plurality of cavities for releasably containing a plurality of transponders, said plurality of cavities having open faces that are defined by sides of said transponder adapter;
wherein said transponder adapter is releasably secured within a key head by a key blade having connecting shoulders that releasably secure to said key head.

18. The transponder adapter according to claim 17 further comprising four transponders positioned within cavities defined by a top side, a bottom side, and a first side of said transponder adapter.

19. The transponder adapter according to claim 17 wherein said transponder adapter is recyclable.

20. The transponder adapter according to claim 17 wherein said transponder adapter is modular for use in combination with a selected key assembly.
